(19) United States
(12) Patent Application Publication
(10) Pub. No.: US 2026/0138326 A1
(43) Pub. Date: May 21, 2026

(54) FOAMED INTERLACED MATERIALS AND ADDITIVELY MANUFACTURING METHODS OF FORMING THE SAME

(71) Applicant: CARBON, INC., Redwood City, CA (US)

(72) Inventor: Kai Chen, Palo Alto, CA (US)

(21) Appl. No.: 19/389,797

(22) Filed: Nov. 14, 2025

Related U.S. Application Data
(60) Provisional application No. 63/720,990, filed on Nov. 15, 2024.

(51) Int. Cl. B29C 64/124; B29C 64/30; B29C 71/02; B29C 71/04; B29K 105/04; B29L 31/48; B33Y 10/00; B33Y 40/20; B33Y 80/00

(52) U.S. Cl. CPC B29C 64/124; B29C 64/30; B29C 71/02; B29C 71/04; B33Y 10/00; B33Y 40/20; B33Y 80/00; B29K 2105/041; B29L 2031/48

(57) ABSTRACT

An additively manufactured fabric includes a plurality of interlaced filaments, and the interlaced filaments include a foamed polymer.

### CROSS-REFERENCE TO RELATED APPLICATION

This application claims priority to U.S. Provisional Application No. 63/720,990, filed on Nov. 15, 2024, the disclosure of which is incorporated herein by reference in its entirety.

### FIELD OF THE INVENTION

The present application relates to additive manufacturing and objects and materials formed by additive manufacturing.

### BACKGROUND OF THE INVENTION

A group of additive manufacturing techniques sometimes referred to as “stereolithography” create a three-dimensional object by the sequential polymerization of a light polymerizable resin. Such techniques may be “bottom-up” techniques, where light is projected into the resin onto the bottom of the growing object through a light transmissive window, or “top down” techniques, where light is projected onto the resin on top of the growing object, which is then immersed downward into a pool of resin.

The introduction of a rapid stereolithography technique sometimes referred to as continuous liquid interface production (CLIP) has expanded the usefulness of stereolithography from prototyping to manufacturing. See e.g., J. Tumbleston, et al., Continuous liquid interface production of 3D objects, Science, 347, 1349-1352; R. Janusziewicz, et al., Layerless fabrication with continuous liquid interface production, PNAS, 113, 11703-11708 (18 Oct. 2016); and U.S. Pat. Nos. 9,211,678; 9,205,601; and 9,216,546.

Air has one of the lowest heat conductivities of all materials and, as such, has excellent heat insulation. When air is trapped with reduced convection, heat insulation performance may improve even further. Accordingly, materials such as aerogels or foams may have desirable thermal insulation properties due to their high air content and low air mobility. However, such materials suffer key challenges when used for wearable applications. Aerogels are generally very brittle. Further, both foams and aerogels generally have low moisture permeability, which may cause sweat to become trapped near the skin of the wearer. One solution has been to form channels in the foam to facilitate vapor diffusion out for the wearing comfort. However, such channels may also reduce the wind resistance of the material. As such, heat insulation materials having improved performance properties would be desirable.

### SUMMARY OF THE INVENTION

Provided according to embodiments of the present invention are additively manufactured fabrics that include a plurality of interlaced filaments, wherein the interlaced filaments comprise a foamed polymer. In some embodiments, the interlaced filaments comprise at least one of knitted filaments, woven filaments, meshes, and interlaced loop filaments (e.g., chain mail structures).

Also provided according to embodiments of the invention are apparel items (e.g., jackets or shoes) and blankets that include an additively manufactured fabric of the invention.

Further provided according to embodiments of the invention are methods of forming an additively manufactured fabric that include (a) producing a fabric comprising a plurality of interlaced filaments from a polymerizable liquid by additive manufacturing (e.g., by bottom-up stereolithography, such as by continuous liquid interface production), wherein the polymerizable liquid comprises heat expandable microspheres; (b) optionally, cleaning the intermediate object (e.g., by washing, spinning, etc.); and (c) heating and/or microwave irradiating the intermediate object for a time and at a temperature sufficient to expand the microspheres. In some embodiments, the polymerizable liquid is a dual cure resin and the expansion of the microspheres occurs before, during, and/or after the second cure (e.g., heating and/or moisture curing) of the intermediate object.

### BRIEF DESCRIPTION OF THE DRAWINGS

The disclosure can be better understood with reference to the following drawings. The components in the figures are not necessarily to scale, emphasis instead being placed upon illustrating the principles of the present disclosure.

FIG. 1 illustrates an example of a foamed filament.

FIG. 2 illustrates an example of a hollow foamed filament.

FIG. 3 illustrates an example of a foamed interlaced material having connected ring structures.

FIG. 4 illustrates an example of a foamed filament ring.

FIG. 5 is a schematic diagram showing an example additive manufacturing system.

### DETAILED DESCRIPTION OF ILLUSTRATIVE EMBODIMENTS

In the following discussion that addresses several embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention. Wherever possible, the same reference numbers are used in the drawings and the following description to refer to the same or similar elements.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

As used herein, a “plurality” of any element refers to two or more of such elements and may include 10%, 20%, 30%, 40%, 50%, 60%, 70%, 80%, 90%, 95%, 99% or 100%, or any range defined therein, of the elements in a part. For example, a plurality of rings in a fabric may include two or more rings within the fabric, or 10%, 20%, 30%, 40%, 50%, 60%, 70%, 80%, 90%, 95%, 99% or 100%, or any range defined between any two of the forgoing values, of the rings in a part. A plurality of rings further includes a majority of the rings (>50%), most of the rings (>70%, >80%, or >90%), substantially all of the rings (>95%), or all of the rings (100%) within the fabric.

All patents or published patent applications referenced are herein incorporated by reference in their entirety. In the case of conflicting terminology, the present application controls.

### Additively Manufactured Fabrics Including Interlaced Filaments

Provided according to embodiments of the invention are additively manufactured fabrics that include a plurality of interlaced foam filaments.

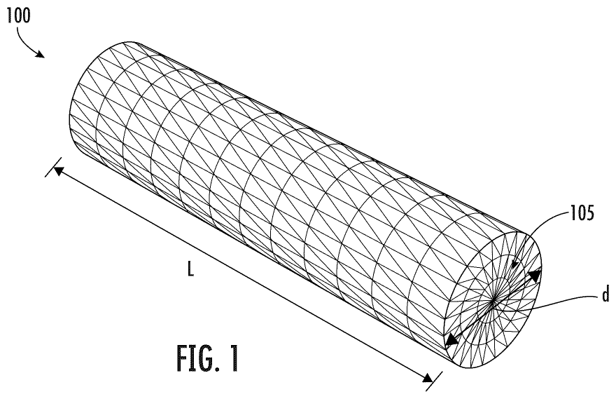

As used herein, a “filament” refers to a thread or fiber-like additively manufactured object. Referring to FIG. 1, in some embodiments, a filament 100 has an aspect ratio (a ratio of its length, l, to its longest width, d) in a range of 5 to 5000 (including in a range of 5 or 10 to 100, 200, 300, 400, 500, 1000, 2000, 3000, 4000, or 5000). The cross-section 105 of the filament 100 may be any suitable shape including, but not limited to, circular, oval, square, polygonal, or irregular. In addition, the cross-section 105 may be uniform in size and/or shape or may vary along the filament 100. The size and shape of the cross-section 105 may also vary from filament 100 to filament 100 in the fabric. In some embodiments, the filaments have a diameter d in a range of 0.5 to 5 mm (e.g., 0.5 mm. 1 mm, 1.5 mm, 2 mm. 2.5 mm, 3 mm, 3.5 mm. 4 mm, 4.5 mm, 5 mm, or any range defined between any two of the foregoing values).

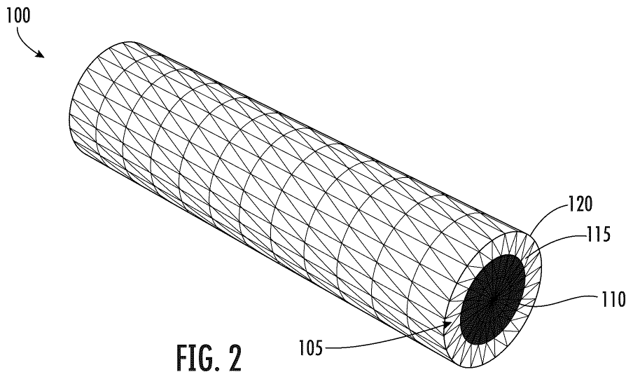

Referring to FIG. 2, in some certain embodiments, filament 100 may have a void space 110 (e.g., hollow core void space) therein. The void space(s) 110 may create at least one internal surface 115, and such internal surface 115 may form a number of possible shapes, including polygonal (e.g., triangular, rectangular, hexagonal), circular, or elliptical, or irregular. In some embodiments, the internal surface 115 has the same shape as the external perimeter 120, as shown in FIG. 2, and in some embodiments, the internal surface 115 has a different shape then the external perimeter 120. In addition, the shape and/or size of the internal surface 115 may vary along the filament 100 and/or between different filaments 100 in the fabric.

While in some embodiments, as shown in FIG. 2, there is only a single void space 110 in the cross-section 105, in some embodiments, there may be multiple void spaces 110 (not shown). The single or multiple void spaces 110 are not created by a foaming agent or process but are printed into the structure by the additive manufacturing process. In some embodiments, the at least one void space 110 has a diameter/length along the shortest cross-section axis is in a range of 0.2 mm to 4.5 mm (e.g., in a range of 0.2 to 1.0 mm, 2.0 mm, 3.0 mm, 4.0 mm, or 4.5 mm). In some embodiments, a void space 110 within the filament 100 is substantially or completely hollow. However, in certain embodiments, an interior filament portion (not shown) may be present within void space 110 and such internal filament portion may or may not be connected to an internal surface 115 of the cross-section 105.

As used herein, the term “interlaced” refers to the intertwining of filaments which may result in an additively manufactured fabric. Interlaced filaments include, but are not limited to, knitted filaments, woven filaments, meshes, and interlaced loop filaments (e.g., chain mail structures). The fabric may also include multiple different kinds of knits, weaves, meshes, or loops and/or may include a combination of woven, knit, mesh, and loop filaments.

Non-limiting examples of knit and woven fabrics include weft-knit, warp-knit, plain weave, twill weave, satin weave, basket weave, jacquard, dobby, leno, crepe, tricot, jersey, interlock, rib, purl, Milanese, Raschel, and the like. Examples of interlaced loop filaments include a plurality of rings wherein each ring is interlaced with at least one (e.g., one, two, three or four) other rings. While in some cases, the interlaced rings are circular, the plurality of rings may also include square, circular, elliptical, and/or irregular toroid rings.

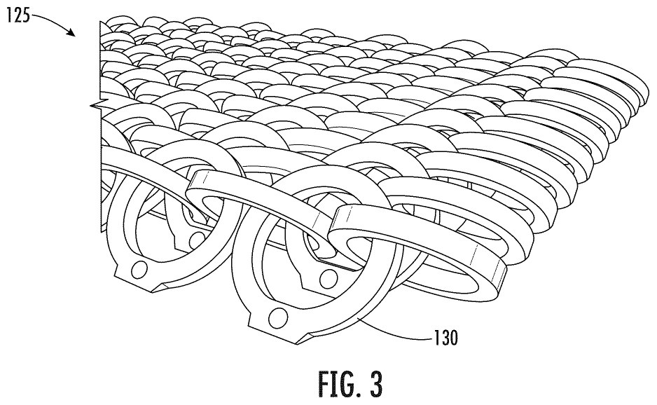

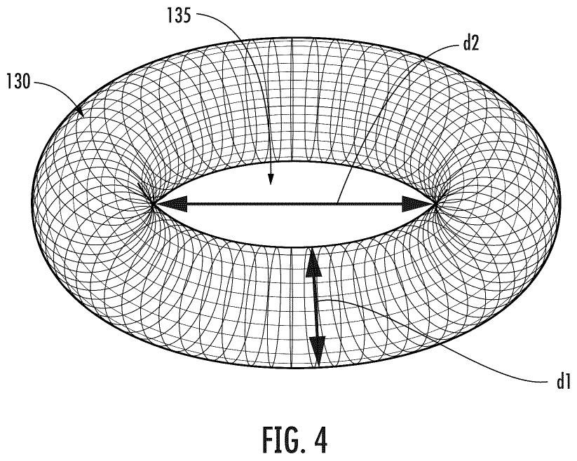

An example of a fabric including interlaced filament rings is shown in FIG. 3. A ring of the interlaced filament rings is shown in FIG. 4. The fabric 125 in FIG. 3 includes a plurality of rings 130. Here, each ring 130 is interlaced with two other loop rings 130 into a chainmail-type structure. While in FIG. 3, the rings 130 are circular and uniform, many other ring structures for the cross-section 105 may be used, including other shapes and sizes as well as a variety of ring sizes and shapes within the fabric 125. For clarity, FIGS. 3-4 show a structure or ring 130 with a circular cross section and a hole 135 therethrough. However, in some embodiments, ring 130 may have different shaped cross-section including polygonal, oval, or irregular. In addition, the size and shape of the cross-section may vary throughout the ring 130. In some embodiments, the diameter (or longest width), d1, of the ring 130 is in a range of 0.2 mm to 10 mm (e.g., 0.2 mm or 0.5 mm to 1 mm to 2 mm, 3 mm, 4 mm, 5 mm, 6 mm, 7 mm, 8 mm, 9 mm or 10 mm). In some embodiments, the diameter or longest width, d2, of the hole 135 in the ring 130 is in a range of 0.2 mm to 20 mm (e.g., 0.2 mm, 0.3 mm, 0.4 mm, 0.5 mm, 0.6 mm, 0.7 mm, 0.8 mm, 0.9 mm, 1.0 mm, 1.2 mm, 1.4 mm, 1.6 mm, 1.8 mm, 2 mm, 3 mm, 10 mm, 20 mm, or any range defined between any two of the foregoing values).

The interlaced filaments of the invention may be foams, such that they include micropores within the filament polymer. In some embodiments, the interlaced filaments comprise micropores having a diameter or longest width in a range of 20 μm to 200 μm (e.g., 20 μm, 40 μm, 60 μm, 80 μm, 100 μm, 120 μm, 140 μm, 160 μm, 180 μm, 200 μm, or any range defined between any two of the foregoing widths). In some embodiments, the micropores are expanded microspheres, as discussed further below.

### Polymer Resins

Resins (also referred to as polymerizable liquids) for additive manufacturing of polymer articles are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone, etc. Any suitable resin may be used to form the filaments and/or fabrics of the invention, including single cure, dual cure, elastomer-forming resins, and thermoset-forming resins. The polymer resins typically include at least one UV reactive monomer or prepolymer; at least one photoinitiator; and heat expandable microspheres. Further, additional optional additives, including but not limited to, reactive diluents, heat and/or moisture-curable monomers or prepolymers, crosslinkers, non-reactive diluents, UV absorbers, pigments, dyes, antioxidants, plasticizers, fillers, radical inhibitors, and thermal inhibitors, may also be present in the polymerizable liquid.

As used herein, the term “heat expandable microsphere” (sometimes referred to as a microballoon, polymeric microsphere, or hollow microbead) refers to a polymer shell (e.g., an elastic and/or thermoplastic polymer shell) having a void space therein that includes a core material (propellant) in the form of a gas, liquid or combination thereof that expands upon heating. The heat expandable microspheres are typically in the micro size range (about 1 μm to about 100 μm) but may in some embodiments be smaller (e.g., about 500 nm to about 1 μm) or larger (about 100 μm to 500 μm) prior to heat expansion. In some embodiments, the polymer shell of the heat expandable microspheres expands without breaking. However, in some embodiments, some or all of the expandable microspheres may break or burst upon expansion. Heat expandable microspheres are typically approximately spherical hollow bodies but may be other shapes and may, in some embodiments, not be entirely hollow and so may be considered partially hollow. In some embodiments, upon heating, the heat expandable microspheres expand so that the diameter is increased by at least 2-10 times and/or the volume is increased by at least 8-fold to 1000-fold. Examples of heat expandable microspheres include but at not limited to those described in U.S. Pat. Nos. 10,030,115; 10,023,712; 9,902,829; 9,062,170; 8,388,809; 10,029,550; and 3,615,972. See also U.S. Pat. No. 11,292,186 to Poelma et al.

The propellant in the core of the heat expandable microspheres is typically a low-boiling liquid (e.g., a liquid with a boiling point at standard pressure of less than 75° C., 100° C., 120° C., 140° C., 160° C., or 200° C.) or with liquefied gas. In some embodiments, the core includes a lower alkane hydrocarbon (C1-C6), for example isobutane and/or isopentane, which are enclosed as liquefied gas under pressure in the polymer shell. The polymer shell is generally formed of a polymer that can expand under the pressure of the encapsulated propellant. In some embodiments, the polymer shell of the heat expandable microsphere includes a polyacrylonitrile, polyvinyl dichloride (PVDC), polyvinyl chloride (PVC), a polyamide and/or a polyacrylate.

In some embodiments, action on the microspheres—more particularly by supply of heat or generation of heat, as for example by ultra-sound or microwave radiation—causes, first, a softening of the outer polymer shell, while at the same time the liquid blowing gas present in the shell undergoes transitions of its gaseous state. At a particular pairing of pressure and temperature the microspheres undergo irreversible expansion and expand three-dimensionally. The expansion ends when the internal pressure equals the external pressure. Since the polymeric shell is maintained, a closed-celled foam may be achieved in this way.

A large number of types of microspheres are available commercially, such as, for example, from Nouryon, the EXPANCEL® DU (dry unexpanded) products, which differ essentially in their size (6 to 45 μm in diameter in the unexpanded state) and in the starting temperature they require for expansion (75° C. to 220° C.). Another example is Advancell® Microspheres from Sekisui Specialty Chemicals. Crerax is another supplier of such expandable microparticles.

Unexpanded types of microballoons are also available in the form of an aqueous dispersion (e.g., with a solids fraction or microballoon fraction of around 40% to 45% by weight), and also in the form of polymer-bound microballoons (masterbatches), for example in ethylene-vinyl acetate (e.g., with a microballoon concentration of around 65% by weight). Obtainable, furthermore, are what are called microballoon slurry systems, in which the microballoons are present in the form of an aqueous dispersion (e.g., with a solids fraction of 60% to 80% by weight). The microballoon dispersions, the microballoon slurries, and the masterbatches, like the DU products, can be used in the process described herein.

The concentration of the heat expandable microspheres in the polymerizable liquid may vary depending on the three-dimensional object and its end use. However, in some embodiments, the heat expandable microspheres are present in the polymerizable liquid at a concentration in a range of about 1% or about 2% by weight to about 35% by weight (e.g., about 1%, about 2%, about 3%, about 4%, about 5%, about 6%, about 7%, about 8%, about 9%, about 10%, about 15%, about 20%, about 25%, about 30%, about 35% by weight, or a range defined between any two of the foregoing values).

### Example Printers & Processes

The additively manufactured fabric as described herein, may be formed by a variety of additive manufacturing processes. For example, additive manufacturing processes include stereolithography, including bottom-up and top-down techniques, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Pat. No. 9,636,873 to Joyce, and U.S. Pat. No. 9,120,270 to Chen et al. Such techniques may be used herein.

In some embodiments, the object is formed by continuous liquid interface production (CLIP). CLIP is known and described in, for example, PCT Publication Nos. WO 2014/126830 (U.S. Pat. No. 9,211,678); WO 2014/126837 (U.S. Pat. No. 9,205,601), WO 2014/126834 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewicz et al., Layerless fabrication with continuous liquid interface production, Proc. Natl. Acad. Sci. USA 113, 11703-11708 (Oct. 18, 2016). In some embodiments, CLIP employs features of a bottom-up three-dimensional fabrication as described above, but the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, U.S. Pat. No. 10,384,439 (Aug. 20, 2019); Sun and Lichkus, Three-dimensional fabricating system for rapidly producing objects, U.S. Patent Application Pub. No. 2016/0288376 (Oct. 6, 2016); Willis et al., 3d print adhesion reduction during cure process, U.S. Pat. No. 9,782,934 (Oct. 10, 2017); Lin et al., Intelligent 3d printing through optimization of 3d print parameters, U.S. Pat. No. 10,073,424 (Sept. 11, 2018); and D. Castanon, Stereolithography System, U.S. Pat. No. 10,118,377 (Nov. 6, 2018).

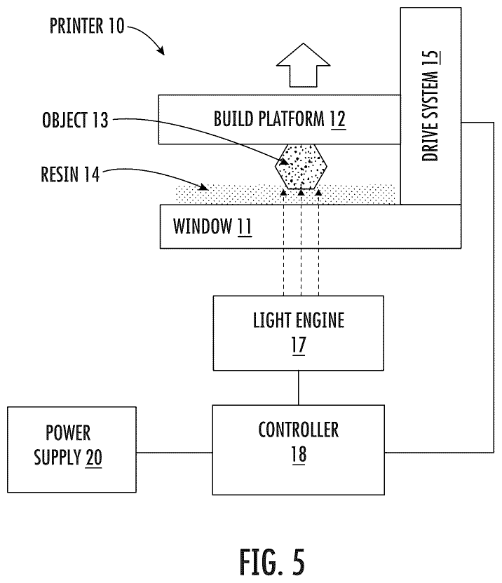

One possible additive manufacturing apparatus is shown in FIG. 5. Here, the additive manufacturing apparatus or 3D printer 10 includes a light transmissive window or optically transparent member 11 on which a light polymerizable resin 14 can be supported. The optically transparent member 11 provides a build surface. A light engine or radiation source 17 is positioned below the optically transparent member 11 and opposite the build surface. A carrier or build platform 12 is positioned above the optically transparent member 11, and an object 13 can be produced thereon. The build surface of the optically transparent member 11 and the build platform 12 define a build region therebetween. A controller 18 powered by a power supply 20 is operatively associated with a drive assembly 15 and the light engine 17 to control the area illuminated by the light engine 17 and the drive assembly 15 to produce the object 13.

In some embodiments of the invention, provided are methods of additively manufacturing a three-dimensional object (e.g., a filament and/or fabric of the invention) that include providing a build platform and an optically transparent member having a build surface, the build platform and optically transparent member defining a build region therebetween, said optically transparent member carrying a polymerizable liquid; irradiating the build region through the optically transparent member to produce a solid polymer portion in the build region; advancing the build platform with the solid polymer portion adhered thereto away from the optically transparent member and/or advancing the optically transparent member away from the build platform, to create a subsequent build region between the solid polymer portion and the build surface, and filling the subsequent build region with the polymerizable liquid; continuing and/or repeating steps (b) and (c) to produce a subsequent solid polymer portion adhered to a previous solid polymer portion until the continued or repeated deposition of solid polymer portions adhered to one another forms the three-dimensional object.

In some embodiments of the invention, the interlaced filaments are first formed by an additive manufacturing process, and then the microspheres in the polymer resin are expanded to form a foam (micropore) structure. If the polymer resin includes a dual cure material, the second cure (e.g., heat and/or moisture cure) may occur before, during, or after the microspheres are expanded.

In some embodiments, the foaming (expansion of the microspheres) includes the volume % of the object/filament after printing (also referred to as an intermediate object) in the range of 100% to 500% (e.g., 100%, 200%, 300%, 400%, 500%, or any range defined any two of the foregoing values), resulting in a high air content layer with flexibility (from the interlaced structure) while the open spaces provide better channels for moisture permeability. Such fabrics provide excellent material for a low weight/thickness layer for cold temperature apparel (e.g., jackets) with great user comfort. Accordingly, also provided according to embodiments of the invention are apparel (e.g., jackets or shoes) or blankets that include an additively manufactured fabric of the invention.

The foregoing is illustrative of the present invention and is not to be construed as limiting thereof. The invention is defined by the following claims, with equivalents of the claims to be included therein.

What is claimed is:

1. An additively manufactured fabric, comprising:
a plurality of interlaced filaments, wherein the interlaced filaments comprise a foamed polymer.

2. The additively manufactured fabric of claim 1, wherein at least one filament comprises a hollow core void space therein.

3. The additively manufactured fabric of claim 1, wherein the interlaced filaments comprise at least one of knitted filaments, woven filaments, meshes, and interlaced loop filaments including chain mail structures.

4. The additively manufactured fabric of claim 3, wherein the fabric comprises at least one of a weft-knit, warp-knit, plain weave, twill weave, satin weave, basket weave, jacquard, dobby, leno, crepe, tricot, jersey, interlock, rib, purl, Milanese, and Raschel.

5. The additively manufactured fabric of claim 3, wherein the interlaced filaments comprise a plurality of interlaced loop filaments comprising ring structures.

6. The additively manufactured fabric of claim 5, wherein the interlaced loop filaments comprise square, circular, elliptical, and/or irregular shaped rings.

7. The additively manufactured fabric of claim 6, wherein a diameter or longest width of a hole in the rings is in a range in a range of 0.2 mm to 20 mm.

8. The additively manufactured fabric of claim 6, wherein each ring of the rings is interlaced with at least two other rings in the fabric, and a width of the interlaced filaments is in a range of 0.2 to 10 mm.

9. The additively manufactured fabric of claim 1, wherein the interlaced filaments comprise micropores having a diameter or longest width in a range of 20 μm to 200 μm.

10. The additively manufactured fabric of claim 1, wherein the foamed polymer comprises a polyurethane, polyurea, a silicone, or a combination thereof.

11. An apparel item comprising the additively manufactured fabric of claim 1.

12. A method of forming an additively manufactured fabric comprising
(a) producing a fabric comprising a plurality of interlaced filaments from a polymerizable liquid by additive manufacturing, wherein the polymerizable liquid comprises heat expandable microspheres;
(b) optionally, cleaning the fabric; and
(c) heating and/or microwave irradiating the fabric for a time and at a temperature sufficient to expand the microspheres.

13. The method of claim 12, wherein the fabric is formed as an intermediate object and the polymerizable liquid is a dual cure resin, and
wherein the fabric is produced during a first cure, the expansion of the microspheres occurs before, during, and/or after a second cure comprising heating and/or moisture curing of the intermediate object.

14. The method of claim 12, wherein at least one filament comprises a hollow core void space therein.

15. The method of claim 12, wherein the interlaced filaments comprise at least one of knitted filaments, woven filaments, meshes, and interlaced loop filaments.

16. The method of claim 12, wherein the fabric comprises at least one of a weft-knit, warp-knit, plain weave, twill weave, satin weave, basket weave, jacquard, dobby, leno, crepe, tricot, jersey, interlock, rib, purl, Milanese, and Raschel.

17. The method of claim 12, wherein the interlaced filaments comprise a plurality of interlaced loop filaments.

18. The method of claim 17, wherein the interlaced loop filaments comprise square, circular, elliptical, and/or irregular shaped rings.

19. The method of claim 18, wherein a diameter or longest width of a hole in the rings is in a range in a range of 0.2 mm to 20 mm.

20. The method of claim 18, wherein each ring of the rings is interlaced with at least two other rings in the fabric.

21. The method of claim 12, wherein a width of the interlaced filaments is in a range of 0.2 to 10 mm.

22. The method of claim 12, wherein the interlaced filaments comprise micropores having a diameter or longest width in a range of 20 μm to 200 μm.

23. The method of claim 12, wherein the polymerizable liquid comprises a polyurethane, polyurea, a silicone, or a combination thereof.
